(19) United States
(12) Patent Application Publication
(10) Pub. No.: US 2010/0228451 A1
(43) Pub. Date: Sep. 9, 2010

(54) HYDRAULIC PRESSURE CONTROLLING APPARATUS

(75) Inventors: Masahiro HOSOYA, Kariya-shi (JP); Yasuo Shirai, Chiryu-shi (JP); Masato Shimei, Nagoya-shi (JP); Osamu Sakamoto, Handa-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 12/716,082

(22) Filed: Mar. 2, 2010

(30) Foreign Application Priority Data
Mar. 9, 2009 (JP) 2009-055373

(51) Int. Cl. G06F 19/00; B60W 10/10

(52) U.S. Cl. 701/51; 477/34

(57) ABSTRACT

A hydraulic pressure controlling apparatus includes a hydraulic pressure controlling portion controlling a hydraulic pressure supplied to plural engagement elements of an automatic transmission apparatus, a mechanical oil pump supplying the hydraulic pressure to the hydraulic pressure controlling portion, an electric oil pump supplying the hydraulic pressure to a starting shift stage engagement element, and an electronic controlling portion controlling operations of the hydraulic pressure controlling portion, a power source and the electronic oil pump based on a signal indicating a predetermined state of a vehicle, wherein the electronic controlling portion controls the hydraulic pressure controlling portion so as to forbid a shifting to a shift stage, which is likely to induce an interlock at the automatic transmission apparatus, based on an engagement of the starting shift stage engagement element in a case where the electronic controlling portion determines that the electric oil pump is in an on-fail state.

### CROSS REFERENCE TO RELATED APPLICATIONS

This application is based on and claims priority under 35 U.S.C. §119 to Japanese Patent Application 2009-055373, filed on Mar. 9, 2009, the entire content of which is incorporated herein by reference.

### TECHNICAL FIELD

This disclosure generally relates to a hydraulic pressure controlling apparatus for controlling a hydraulic pressure supplied to an engagement element of a hydraulic automatic transmission apparatus mounted on a vehicle.

### BACKGROUND

There exists an engine stop-and-start controlling apparatus for executing a control of automatically stopping an engine when an engine stopping condition is satisfied in a case where a vehicle travels and temporarily stops at an intersection and the like and re-starting the engine when an engine starting condition is satisfied when the vehicle starts moving afterwards. The engine stop-and-start controlling apparatus may include a hydraulic pressure controlling device for controlling a hydraulic pressure so that sufficient operation oil is supplied to an engagement element of a hydraulic automatic transmission in order to reduce a shock generated when clutches of the hydraulic automatic transmission are engaged when the engine is re-started.

For example, disclosed in JP2003-172165A is a drive control apparatus, which hydraulically controls an engagement of a friction engagement element and which includes at least a mechanical oil pump driven by an engine and supplying a hydraulic pressure to a hydraulic pressure controlling device, and an electric oil pump for supplying the hydraulic pressure to the hydraulic pressure controlling device. The drive control apparatus disclosed in JP2003-172165A further includes an automatic transmission apparatus for transmitting a driving force of the engine to wheels in response to the engagement of the friction engagement element and a motor connected to the mechanical oil pomp in order to drive the mechanical oil pump in response to an operation of the motor and transmitting a driving force to the automatic transmission apparatus. The drive control apparatus disclosed in JP2003-172165A is configured so as to supply an oil to the hydraulic pressure controlling device in response to an operation of the electric oil pump in a case where an engine automatic control for automatically stopping a driving of the engine is executed in a case where the vehicle stops and a predetermined condition is satisfied. On the other hand, in a case where the electric oil pump is incapable of being driven, the drive control apparatus disclosed in JP2003-172165A drives the motor, so that the mechanical oil pump supplies the oil to the hydraulic pressure controlling device while the engine is automatically stopped.

According to the drive control apparatus disclosed in JP2003-1782165A, the oil, which is discharged either from the mechanical oil pump or the electric oil pump, is supplied to a forward clutch and an accumulator via a manual shift valve and a neutral relay valve. In a case where the accumulator of the drive control apparatus disclosed in JP2003-172165A is configured on a hydraulic circuit of the automatic transmission apparatus, a separate and specific hydraulic circuit including the neutral relay valve and the accumulator needs to be provided at the drive control apparatus. Accordingly, re-designing and providing the separate and specific hydraulic circuit to the drive control apparatus may lead to an increase of manufacturing costs thereof.

Furthermore, according to the drive control apparatus disclosed in JP2003-172165A, the electric oil pump is turned to be in a control incapable state while the electric oil pump is being driven (i.e. on-fail state) in a case where the manual shift valve is shifted at a D range. Furthermore, in this case, if the neutral relay valve is turned to be in a control incapable state while the neutral relay valve connects the forward clutch and the manual shift valve, the forward clutch is turned to be in a normally engaged state. In the driving control disclosed in JP2003-172165A, an automatic transmission apparatus, which includes gear trains and in which the forward clutch is engaged in order to establish forward shift stages is adapted. However, in a case where an automatic transmission apparatus, in which different clutches are engaged in order to establish different forward shift stages, is adapted as the automatic transmission apparatus, a double engagement state (i.e. an interlock state) may occur within the automatic transmission apparatus. Therefore, in this case, the automatic transmission apparatus may not be adapted to the drive control apparatus because of safety reasons.

A need thus exists to provide a hydraulic pressure controlling apparatus which is not susceptible to the drawback mentioned above.

### SUMMARY

According to an aspect of this disclosure, a hydraulic pressure controlling apparatus includes a hydraulic pressure controlling portion controlling a hydraulic pressure supplied to a plurality of engagement elements of an automatic transmission apparatus, a mechanical oil pump supplying the hydraulic pressure to the hydraulic pressure controlling portion in response to a driving of a power source, an electric oil pump supplying the hydraulic pressure to a starting shift stage engagement element, which is one of the plural engagement elements used for establishing a starting shift stage, and an electronic controlling portion controlling operations of the hydraulic pressure controlling portion, the power source and the electronic oil pump on the basis of a signal indicating a predetermined state of a vehicle, wherein the electronic controlling portion controls the hydraulic pressure controlling portion so as to forbid a shifting to a shift stage, which is likely to induce an interlock at the automatic transmission apparatus, on the basis of an engagement of the starting shift stage engagement element in a case where the electronic controlling portion determines that the electric oil pump is in an on-fail state.

According to another aspect of this disclosure, a hydraulic pressure controlling apparatus includes a hydraulic pressure controlling portion controlling a hydraulic pressure supplied to a plurality of engagement elements of an automatic transmission apparatus, a mechanical oil pump supplying the hydraulic pressure to the hydraulic pressure controlling portion in response to a driving of a power source, an electric oil pump supplying the hydraulic pressure to a starting shift stage engagement element, which is one of the plurality of engagement elements used for establishing a starting shift stage, an electronic controlling portion controlling operations of the hydraulic pressure controlling portion, the power source and the electronic oil pump on the basis of a signal indicating a predetermined state of a vehicle, and a hydraulic pressure supply interrupting mechanism for interrupting a supply of the hydraulic pressure from the electric oil pump to the starting shift stage engagement element.

According to a further aspect of this disclosure, s hydraulic pressure controlling apparatus includes a hydraulic pressure controlling portion controlling a hydraulic pressure supplied to a plurality of engagement elements of an automatic transmission apparatus, a mechanical oil pump supplying the hydraulic pressure to the hydraulic pressure controlling portion in response to a driving of a power source, an electric oil pump supplying the hydraulic pressure to a starting shift stage engagement element, which is one of the plurality of engagement elements used for establishing a starting shift stage, a solenoid provided at a branched hydraulic conduit, which is a hydraulic conduit branched from a hydraulic conduit extending between the electric oil pump and the starting shift stage engagement element, and an electronic controlling portion controlling operations of the hydraulic pressure controlling portion, the power source, the electronic oil pump and the solenoid on the basis of a signal indicating a predetermined state of a vehicle.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a diagram schematically illustrating a configuration example of a hydraulic pressure controlling apparatus according to a first embodiment;

FIG. 2A is a skeleton diagram schematically illustrating a gear train of an automatic transmission adapted to the hydraulic pressure controlling apparatus according to the first embodiment;

FIG. 2B is a table schematically indicating relationships between first, second and third friction clutches, operation states of first and second friction brakes, and shift stages;

FIG. 3 is a flowchart schematically illustrating a control operation of an engine controlling portion of the hydraulic pressure controlling apparatus according to the first embodiment;

FIG. 4 is a diagram schematically illustrating a configuration example of a hydraulic pressure controlling apparatus according to a second embodiment; and

FIG. 5 is a diagram schematically illustrating a configuration example of a hydraulic pressure controlling apparatus according to a third embodiment.

### DETAILED DESCRIPTION

### Overview

A hydraulic pressure controlling apparatus according to a first embodiment includes a hydraulic pressure controlling portion 10 for controlling a hydraulic pressure to be supplied to plural engagement elements C1, C2, C3, B1 and B2 provided within an automatic transmission apparatus, a mechanical oil pump 2 for supplying the hydraulic pressure to the hydraulic pressure controlling portion 10 in response to an operation of a power source 3, an electric oil pump 21 for supplying the hydraulic pressure to a starting shift stage engagement element C1 used for a starting shift stage out of plural engagement elements, and electronic controlling portions (an engine controlling portion 4, a transmission controlling portion 5 and an electric oil pump controlling portion 23) for controlling operations of the hydraulic pressure controlling portion 10, the power source 3 and the electric oil pump 2, respectively, on the basis of a signal indicating a predetermined state of a vehicle. The electronic controlling portions 4, 5 and 23 controls the hydraulic pressure controlling portion 10 so as to forbid a gear change to a shift stage that generates an interlock within the automatic transmission apparatus in response to an engagement of the starting shift stage engagement element in a case where the electronic control portion determines that the electric oil pump 21 is in an on-fail state.

A hydraulic pressure controlling apparatus according to a second embodiment includes a hydraulic pressure controlling portion 10 for controlling a hydraulic pressure to be supplied to plural engagement elements C1, C2, C3, B1 and B2 provided within an automatic transmission apparatus, a mechanical oil pump 2 for supplying the hydraulic pressure to the hydraulic pressure controlling portion 10 in response to an operation of a power source 3, an electric oil pump 21 for supplying the hydraulic pressure to a starting shift stage engagement element C1 used for a starting shift stage out of plural engagement elements, electronic controlling portions (an engine controlling portion 4, a transmission controlling portion 5 and an electric oil pump controlling portion 23) for controlling operations of the hydraulic pressure controlling portion 10, the power source 3 and the electric oil pump 2, respectively, on the basis of a signal indicating a predetermined state of a vehicle, and one or more of a manual switch, which is configured so as to interrupt an electric power supply path between an electric power source 6 and the electric oil pump 21 and which serves as a hydraulic pressure supply interrupting mechanism.

A hydraulic pressure controlling apparatus according to a third embodiment includes a hydraulic pressure controlling portion 10 for controlling a hydraulic pressure to be supplied to plural engagement elements C1, C2, C3, B1 and B2 provided within an automatic transmission apparatus, a mechanical oil pump 2 for supplying the hydraulic pressure to the hydraulic pressure controlling portion 10 in response to an operation of a power source 3, an electric oil pump 21 for supplying the hydraulic pressure to a starting shift stage engagement element C1 used for a starting shift stage out of plural engagement elements, electronic controlling portions (an engine controlling portion 4, a transmission controlling portion 5 and an electric oil pump controlling portion 23) for controlling operations of the hydraulic pressure controlling portion 10, the power source 3 and the electric oil pump 2, respectively, on the basis of a signal indicating a predetermined state of a vehicle, and a manual valve 33, which is configured so as to interrupt a hydraulic path between an oil pan 1 and the electric oil pump 21 and which serves as a hydraulic pressure supply interrupting mechanism.

A hydraulic pressure controlling apparatus according to a fourth embodiment includes a hydraulic pressure controlling portion 10 for controlling a hydraulic pressure to be supplied to plural engagement elements C1, C2, C3, B1 and B2 provided within an automatic transmission apparatus, a mechanical oil pump 2 for supplying the hydraulic pressure to the hydraulic pressure controlling portion 10 in response to an operation of a power source 3, an electric oil pump 21 for supplying the hydraulic pressure to a starting shift stage engagement element C1 used for a starting shift stage out of plural engagement elements, a solenoid 34 provided at a branched hydraulic conduit, which is a hydraulic conduit branched from a hydraulic conduit (i.e. a first hydraulic conduit) extending between the electric oil pump 21 and the starting shift stage engagement element C1, and electronic controlling portions (an engine controlling portion 4, a transmission controlling portion 5 and an electric oil pump controlling portion 23) for controlling operations of the hydraulic pressure controlling portion 10, the power source 3, the electric oil pump 2, and the solenoid, respectively, on the basis of a signal indicating a predetermined state of a vehicle.

### First Embodiment

A hydraulic pressure controlling apparatus according to a first embodiment will be described below with reference to the attached drawings.

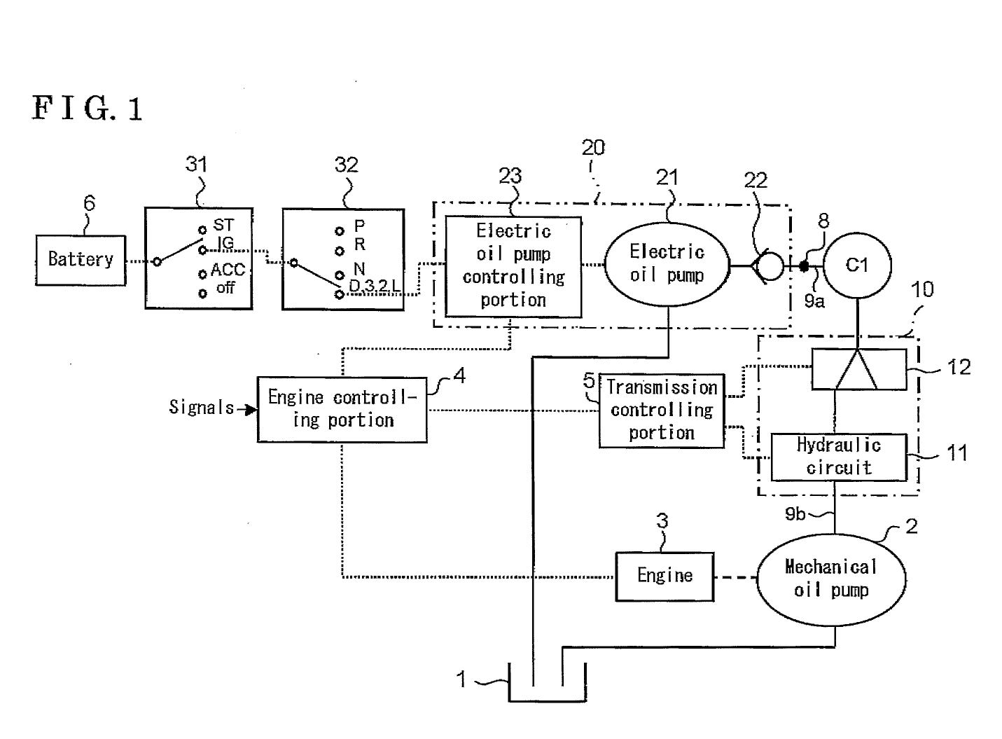

The hydraulic pressure controlling apparatus controls the hydraulic pressure supplied to the engagement elements of a hydraulic automatic transmission apparatus mounted on the vehicle. For example, the hydraulic pressure controlling apparatus may be adapted to an engine stop-and-start controlling apparatus, which automatically stops an engine 3 (an example of the power source) in a case where a stopping condition is satisfied when the vehicle stops (temporarily stops) at an intersection and the like while the vehicle is traveling and which automatically re-starts the engine 3 in a case where the staring condition is satisfied afterwards. More specifically, as illustrated in FIG. 1, the hydraulic pressure controlling apparatus includes an oil pan 1, the mechanical oil pump 2, the engine 3, the engine controlling portion 4, the transmission controlling portion 5, a battery 6, a clutch C1 (i.e. a starting state engagement element, a first friction clutch C1), a C1 hydraulic pressure detection port 8, the hydraulic pressure controlling portion 10, a hydraulic pressure maintaining portion 20, an ignition switch 31 and a shift position switch 32.

The oil pan 1 is a container for accumulating (accommodating) an operation oil (an oil, an operation fluid) supplied to the hydraulic pressure controlling portion 10, the hydraulic pressure maintaining portion 20 and the like of the automatic transmission apparatus. More specifically, the operation oil drained from the hydraulic controlling portion 10 flows into the oil pan 1. The oil pan 1 includes therein a strainer for removing dust and the like contained in the operation oil. The operation oil within the oil pan 1 is supplied to the mechanical oil pump 2, the electric oil pump 21 and the like via the strainer.

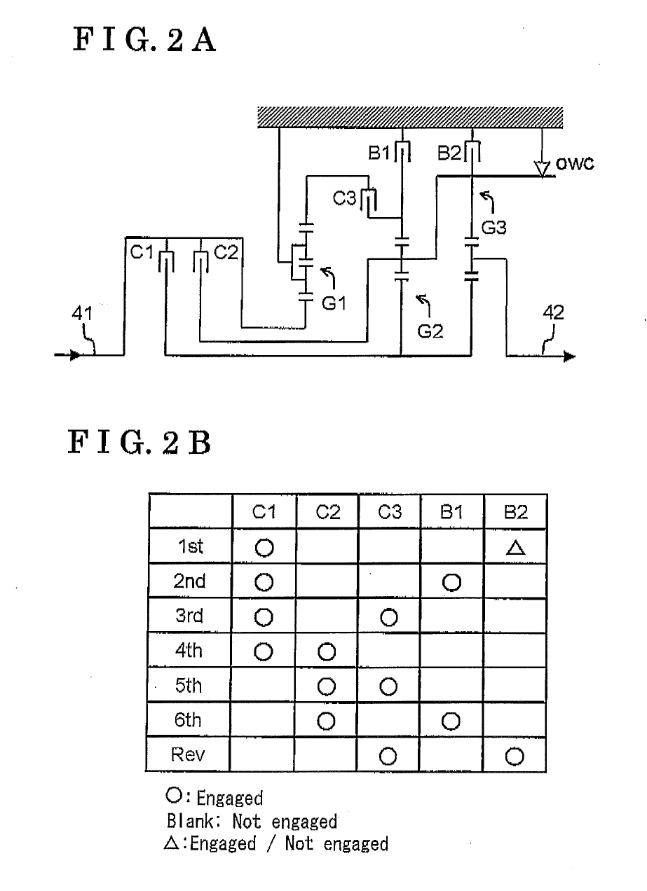

The mechanical oil pump 2 is an oil pump, which is actuated in response to a rotational power generated by the engine 3. The mechanical oil pump 2 itself does not include a power source. The mechanical oil pump 2 generates the hydraulic pressure for engaging mainly the engagement elements (C1, C2, C3, B1 and B2 in FIG. 2) used for establishing an appropriate shift stage within the automatic transmission apparatus. More specifically, the mechanical oil pump 2 sucks the operation oil within the oil pan 1 and discharges the operation oil to a hydraulic circuit 11 of the hydraulic pressure controlling portion 10. Additionally, in this embodiment, the engine 3 serves as the power source for the mechanical oil pump 2. However, in a case where the hydraulic pressure controlling apparatus is adapted to a hybrid vehicle, an engine and a motor serve as power sources for the mechanical oil pump 2. On the other hand, in a case where the hydraulic pressure controlling apparatus is adapted to an electric vehicle, a motor serves as a power source for the mechanical oil pump 2.

The engine 3 is an internal combustion engine, which outputs the rotational power in response to combustion of a fuel. The rotational power generated by the engine 3 is transmitted to an input shaft 41 (see FIG. 2) of the automatic transmission apparatus via a torque converter. The engine 3 drives the mechanical oil pump 2. Furthermore, the engine 3 includes various actuators for adjusting an amount of fuel injection (including fuel cut) from an injector, an ignition timing and the like, and various sensors for detecting a number of rotations of the engine 3 (i.e. an engine rotating number, an engine rotating speed), an engine water temperature and the like. The amount of the fuel injection, the ignition timing and the like of the engine 3 are controlled by the engine controlling portion 4. A signal outputted from each sensor of the engine 3 is inputted to the engine controlling portion 4.

The engine controlling portion 4 is a computer that controls mainly each actuator of the engine 3. The engine controlling portion 4 executes a control processing on the basis of a predetermined program (including a database, a map and the like). The engine controlling portion 4 outputs various control signals to the engine 3, the transmission controlling portion 5, an electric oil pump controlling portion 23 and the like. Furthermore, various signals from an acceleration opening degree sensor, a shift position sensor, a rotation sensor and the like are inputted into the engine controlling portion 4. The engine controlling portion 4 may be electrically connected to each sensor. Alternatively, the engine controlling portion 4 may be electrically connected to each sensor via the transmission controlling portion 5, the electric oil pump controlling portion 23 or the like. The engine controlling portion 4 exchanges information with the transmission controlling portion 5 and the electric oil pump controlling portion 23. Furthermore, the engine controlling portion 4 controls automatic stop and re-start of the engine 3. In this embodiment, because the hydraulic pressure controlling apparatus is adapted to an engine-driven vehicle, the engine controlling portion 4 is provided at the hydraulic pressure controlling apparatus. Alternatively, in the case where the hydraulic pressure controlling apparatus is adapted to the hybrid vehicle, a hybrid controlling portion or an engine controlling portion may be used. On the other hand, in the case where the hydraulic pressure controlling apparatus is adapted to the electric vehicle, a motor controlling portion may be used.

The engine controlling portion 4 determines whether or not a driving condition of the electric oil pump 21 (i.e. a condition of driving the electric oil pump 21) is satisfied. In a case where the engine controlling portion 4 determines that the driving condition of the electric oil pump 21 is satisfied, the engine controlling portion 4 controls the electric oil pump 21 to be driven and simultaneously, the engine controlling portion 4 controls a shift valve 12 to be in an interrupting state (i.e. a state of interrupting a flow of the operation oil) and controls the engine 3 to be stopped. On the other hand, in a case where the engine controlling portion 4 determines that the driving condition of the electric oil pump 21 is not satisfied, the engine controlling portion 4 controls the electric oil pump 21 to be stopped and simultaneously, the engine controlling portion 4 controls the shift valve 12 to be in an establishing state (i.e. a state of establishing (allowing) the flow of the operation oil) and controls the engine 3 to be re-started. A condition indicative of drivability of the electric oil pump 21 is used as the driving condition. For example, a condition such as an oil temperature being equal to or lower than a predetermined value, the engine rotating number being equal to or lower than a predetermined value, a battery level being equal to or greater than a predetermined value and the like, which are preliminarily set within the program of the engine controlling portion 4, are used as the driving condition.

The engine controlling portion 4 monitors a fail state (the on-fail and an off-fail) of the electric oil pump 21 via the electric oil pump controlling portion 23, so that the engine controlling portion 4 controls the engine 3, and so that the engine controlling portion 4 controls the hydraulic circuit 11 and the shift valve 12 via the transmission controlling portion 5 in response to the fail state of the electric oil pump 21. More specifically, in a case where the electric oil pump 21 is in the on-fail state, the engine controlling portion 4 controls the automatic transmission apparatus so as not to establish a shift stage (e.g. a fifth shift stage, a sixth shift state and a reverse shift stage) which does not use the first friction clutch C1. An operation of the engine controlling portion 4 will be described in more detail later.

The transmission controlling portion 5 is a computer that controls an operation of the hydraulic pressure controlling portion 10 of the automatic transmission apparatus. More specifically, the transmission controlling portion 5 controls an operation of each of various solenoids provided at the hydraulic circuit 11 and the shift valve 12. Furthermore, the various signals outputted from various sensors, such as a hydraulic pressure sensor, a hydraulic pressure switch and the like of the hydraulic pressure controlling portion 10, are inputted into the transmission controlling portion 5. The transmission controlling portion 5 exchanges information with the engine controlling portion 4.

As illustrated in FIG. 2A, the automatic transmission apparatus includes, for example, the input shaft 41, an output shaft 42, a first train double pinion planetary gear G1, a second train single pinion planetary gear G2, a third train single pinion planetary gear G3 and the engagement elements (C1, C2, C3, B1 and B2). The input shaft 41 is rotated together with an input portion of the first friction clutch C1, an input portion of the second friction clutch C2 and a sun gear of the first train double pinion planetary gear G1 as a unit. An output portion of the first friction clutch C1 is rotated together with a sun gear of the second train single pinion planetary gear G2 and a sun gear of the third train single pinion planetary gear G3 as a unit. An output portion of the second friction clutch C2 is rotated together with a carrier, which rotatably supports a pinion of the second train single pinion planetary gear G2, a ring gear of the third single pinion planetary gear G3, a rotating portion of the second friction brake B2, and a rotating portion of a one-way clutch OWC as a unit. An inner pinion and an outer pinion of the first train double pinion planetary gear G1 are rotatably supported by a carrier, which is fixed at a case. A ring gear of the first train double pinion planetary gear G1 is rotated together with an input portion of the first friction clutch C1 as a unit. A ring gear of the second train single pinion planetary gear G2 is rotated together with an output portion of the third friction clutch C3 and a rotating portion of the first friction brake B1 as a unit. Fixing portions of the first friction brake B1, the second friction brake B2 and the one-way clutch are fixed at the case. The third train single pinion planetary gear G3 is rotatably supported by a carrier, which is rotated together with the output shaft 42 as a unit.

The automatic transmission apparatus is configured so as to switch the shift stages (see FIG. 2B) in response to a selection of engagement and disengagement of the engagement elements (C1, C2, C3, B1 and B2 in FIG. 2A) controlled by the transmission controlling portion 5 and the hydraulic pressure controlling portion 10. In a case where only the first friction clutch C1 (or only the first friction clutch C1 and the second friction brake B2) of the automatic transmission apparatus is engaged, a first shift stage is established. In a case where only the first friction clutch C1 and the second friction brake B1 of the automatic transmission apparatus are engaged, a second shift stage is established. In a case where only the first friction clutch C1 and the third friction clutch C3 of the automatic transmission apparatus are engaged, a third shift stage is established. In a case where only the first friction clutch C1 and the second friction clutch C2 of the automatic transmission apparatus are engaged, a fourth shift stage is established. In a case where only the second friction clutch C2 and the third friction clutch C3 of the automatic transmission apparatus are engaged, the fifth shift stage is established. In a case where only the second friction clutch C2 and the first friction brake B1 of the automatic transmission apparatus are engaged, the sixth shift stage is established. Furthermore, in a case where only the third friction clutch C3 and the second friction brake B2 of the automatic transmission apparatus are engaged, the reverse stage is established, In a case where the engine 3 is re-started after being automatically stopped, only the first friction clutch C1 serving as a starting clutch is engaged. Additionally, in the case where the electric oil pump 21 is in the on-fail state, the first friction clutch C1 is engaged when establishing any shift stage. Therefore, in the case where, for example, the fifth shift stage is established, the first friction clutch C1, the second friction clutch C2 and the third friction clutch C3 are simultaneously engaged. In other words, in this case, a double engagement (i.e. the interlock) may occur. Furthermore, in the case where, for example, the sixth shift stage is established, the first friction clutch C1, the second friction clutch C2 and the first friction brake B1 are simultaneously engaged (i.e. the double engagement may occur). Even in the case where the reverse shift stage is established, the first friction clutch C1, the third friction clutch C3 and the second friction brake B2 are simultaneously engaged, in other words, the double engagement occurs.

The battery 6 is a portion that accumulates therein an electric power. The battery 6 outputs the electric power to the electric oil pump controlling portion 23 via the ignition switch 31 and the shift position switch 32.

The first friction clutch C1 is an engagement element used for establishing the starting shift stage within the automatic transmission apparatus. More specifically, the first friction clutch C1 is pressed against a piston so as to be frictionally engaged in a case where a hydraulic pressure within a hydraulic pressure chamber of the first friction clutch C1 becomes high.

The C1 hydraulic pressure detection port 8 is a detection port provided on the hydraulic path in order to detect the hydraulic pressure (C1 hydraulic pressure) within the hydraulic pressure chamber of the piston, which is used for engaging the first friction clutch C1. The C1 hydraulic pressure detection port 8 is connected to the hydraulic conduit led to a check valve 22 (i.e. a first check valve) of the hydraulic pressure maintaining portion 20. Generally, the C1 hydraulic pressure detection portion 8 is provided at the hydraulic conduit in order to connect thereto the hydraulic pressure sensor for detecting the C1 hydraulic pressure. However, in this embodiment, the hydraulic pressure sensor is not connected to the C1 hydraulic pressure detection portion 8, instead, the hydraulic conduit (i.e. the first hydraulic conduit 9a) led to the check valve 22 is connected to the C1 hydraulic pressure detection port 8. Accordingly, a design change of the hydraulic pressure controlling portion 20 may become unnecessary.

The hydraulic pressure controlling portion 10 controls the hydraulic path and the hydraulic pressure of the operation oil supplied to the engagement elements of the automatic transmission apparatus. The hydraulic pressure controlling portion 10 includes the hydraulic circuit 11 and the shift valve 12.

The hydraulic circuit 11 controls the hydraulic path and adjusts the hydraulic pressure of the operation oil supplied thereto from the mechanical oil pump 2 in response to the control of the transmission controlling portion 5. Then, the hydraulic circuit 11 through a hydraulic conduit (i.e. a second hydraulic conduit 9b that is connected to the hydraulic pressure controlling portion 10) outputs the operation oil, whose pressure level is adjusted, to the shift valve 12. The hydraulic circuit 11 is configured with an appropriate combination of various valves, various solenoids and the like. Furthermore, the hydraulic circuit 11 controls the hydraulic path and adjusts the hydraulic pressure for other engagement elements (C2, C3, B1 and B2) in addition to the control and adjustment of the hydraulic path and the hydraulic pressure for the first friction clutch C1.

The shift valve 12 switches an establishment and an interruption of the hydraulic path (i.e. a flow of the operation oil) between the hydraulic circuit 11 and the first friction clutch C1. More specifically, the shift valve 12 executes the switching of the establishment and the interruption of the flow of the operation oil in response to an operation of the solenoid, which is controlled by the transmission controlling portion 5. For example, in a case where the engine 3 rotates, the shift valve 12 allows the operation oil to flow through the hydraulic conduit extending between the hydraulic circuit 11 and the first friction clutch C1. On the other hand, in a case where the engine 3 does not rotate but the electric oil pump 21 is driven, the shift valve 12 interrupts the flow of the operation oil between the hydraulic circuit 11 and the first friction clutch C1. Additionally, the shift valve 12 may be configured so as to be included within the hydraulic circuit 11.

The hydraulic pressure maintaining portion 20 maintains the hydraulic pressure at a sufficient level to engage the engagement element (i.e. the first friction clutch C1) used to form the starting shift stage in the case where the engine 3 is automatically stopped and the mechanical oil pump 2 is stopped, accordingly. The hydraulic pressure maintaining portion 20 is not configured within the hydraulic controlling portion 10. In other words, the hydraulic pressure maintaining portion 20 is configured separately of the hydraulic pressure controlling portion 10. The hydraulic pressure maintaining portion 20 includes the electric oil pump 21, the check valve 22 and the electric oil pump controlling portion 23.

The electric oil pump 21 is an electric oil pump driven by a motor. The electric oil pump 21 is provided at the hydraulic pressure controlling apparatus in order to support the mechanical oil pump 2. More specifically, the electric oil pump 21 generates the hydraulic pressure for engaging the engagement element (i.e. the first friction clutch C1) used to form the starting shift stage within the automatic transmission apparatus. The electric oil pump 21 sucks the operation oil within the oil pan 1 and discharges the operation oil to the check valve 22. Additionally, the electric oil pump 21 is controlled by the electric oil pump controlling portion 23.

The check valve 22 is a one-way valve that allows the operation oil to flow to the first friction clutch C1 from the electric oil pump 21 in a case where the hydraulic pressure at the electric oil pump 21 is greater than the hydraulic pressure at the first friction clutch C1. On the other hand, in a case where the hydraulic pressure at the electric oil pump 21 is lower than the hydraulic pressure at the first friction clutch C1, the check valve 22 prevents the reverse flow of the hydraulic oil, so that the operation oil from the electric oil pump 21 is not supplied to the first friction clutch C1.

The electric oil pump controlling portion 23 is a controlling portion that controls the driving of the electric oil pump 21. The electric oil pump controlling portion 23 is electrically connected to the battery 6 via the ignition switch 31 and the shift position switch 32. The electric oil pump controlling portion 23 controls the driving of the electric oil pump 21 in a manner where the electric oil pump controlling portion 23 controls the electric power supplied to the electric oil pump 21 from the battery 6 on the basis of the control signal outputted from the engine controlling portion 4. Various signals from various sensors, such as the rotating number sensor and the like of the electric oil pump 21 are inputted to the electric oil pump controlling portion 23. Furthermore, the electric oil pump controlling portion 23 exchanges information with the engine controlling portion 4.

The ignition switch 31 is a switch for opening and closing a pathway in response to a rotational position of a key, which is inserted into the ignition switch and which is rotated in order to start the engine 3. The ignition switch 31 is provided on a wiring between the battery 6 and the electric oil pump controlling portion 23. The ignition switch 31 is turned on in a case where the key is rotated at a position IG (i.e. an ignition power source). On the other hand, in a case where the key is rotated at any position other than the position IG (e.g. at a position ST (a starter power source), a position ACC (an accessory power source), off), the ignition switch 31 is turned off. Additionally, the hydraulic pressure controlling apparatus may be modified so that the shift position switch 32 is arranged closer to the battery 6 relative to the ignition switch 31, as long as the ignition switch 31 and the shift position switch 32 are arranged in series on the wiring between the battery 6 and the electric oil pump controlling portion 23.

The shift position switch 32 is a switch for opening and closing a pathway in response to a position of a gear lever. The shift position switch 32 is provided on the wiring between the battery 6 and the electric oil pump controlling portion 23. The shift position switch 32 is turned on in a case where the gear lever is positioned at any forward shift stage (e.g. a D range, a 3rd range, a 2nd range, and L range). On the other hand, in a case where the gear lever is positioned at any position other than the forward shift stages (e.g. a N range, an R range and a P range), the shift position switch 32 is turned off. Additionally, the hydraulic pressure controlling apparatus may be modified so that the shift position switch 31 is arranged closer to the electric oil pump controlling portion 23 relative to the ignition switch 31, as long as the ignition switch 31 and the shift position switch 32 are arranged in series on the wiring between the battery 6 and the electric oil pump controlling portion 23.

The operation of the hydraulic pressure controlling apparatus according to the first embodiment will be described below.

In a case where only the engine 3 is driven, the mechanical oil pump 2 is actuated in response to the rotation of the engine 3, thereby sucking the operation oil from the oil pan 1. The operation oil discharged from the mechanical oil pump 2 is supplied to the first friction clutch C1 via the hydraulic circuit 11 and the shift valve 12, which are controlled so that the hydraulic pressure is supplied to the first friction clutch C1. The flow of the operation oil supplied to the first friction clutch C1 is stopped at the check valve 22, so that the operation oil does not flow into the electric oil pump 21. Additionally, in this case, because the engine controlling portion 4 controls the engine 3 to be driven, the shift valve 12 is also controlled via the transmission controlling portion 5 so as to establish the hydraulic path of the operation oil between the first friction clutch C1 and the hydraulic circuit 11.

In a case where only the electric oil pump 21 is actuated, the electric oil pump 21 sucks the operation oil from the oil pan 1 in response to the driving of the electric oil pump 21. The operation oil discharged from the electric oil pump 21 is supplied to the first friction clutch C1 via the check valve 22 and the C1 hydraulic pressure detection port 8. In this case, the flow of the operation oil between the first friction clutch C1 and the hydraulic circuit 11 is interrupted by the shift valve 12. Therefore, the operation oil supplied to the first friction clutch C1 from the electric oil pump 21 does not flow into the hydraulic circuit 11. Accordingly, leakage of the operation oil is limited to a small amount leaked from a clearance formed at the shift valve 12, in other words, the leakage of the operation oil is limited to a very small amount. Therefore, the electric oil pump 21 may be configured so as to have a minimum volume necessary for engaging the first friction clutch C1. Additionally, the electric oil pump 21 is controlled to be driven by the electric oil pump controlling portion 23, which receives a control command from the engine controlling portion 4, in order to control the hydraulic pressure and the flow of the operation oil so as to be sufficient to engage the first friction clutch C1. Furthermore, the engine controlling portion 4 monitors a condition of the vehicle such as the engine rotating number (i.e. the engine rotating speed), the oil temperature, the hydraulic pressure, a failure, a battery residual pressure and the like on the basis of the signals outputted from various sensors in order to output a control command corresponding to the monitored vehicle condition to the electric oil pump controlling portion 23. The engine controlling portion 4 controls the shift valve 12 via the transmission controlling portion 5 in order to interrupt the flow of the operation oil at the hydraulic conduit extending between the first friction clutch C1 and the hydraulic circuit 11 in a case where the engine controlling portion 4 controls the electric oil pump 21 to be driven and the engine 3 to be stopped. In this case, the ignition switch 31 is in an ON-state and the key is rotated at the position IG. Furthermore, the shift position switch 32 is in an ON-state and the gear lever is positioned at the forward shift stage.

In a case where both of the electric oil pump 21 and the engine 3 are driven, the operation oil is supplied to the first friction clutch C1 from the mechanical oil pump 2 and the electric oil pump 21. In this case, the hydraulic path of the operation oil is established between the first friction clutch C1 and the hydraulic circuit 11 via the shift valve 12. Furthermore, a greater amount of the operation oil is supplied to the first friction clutch C1 from the mechanical oil pump 2 when comparing to an amount of the operation oil supplied to the first friction clutch C1 from the electric oil pump 21. However, because the flow of the operation oil supplied to the first friction clutch C1 from the mechanical oil pump 2 is interrupted by the check valve 22, the operation oil does not flow into the electric oil pump 21. Additionally, the engine controlling portion 4 controls the shift valve 12 via the transmission controlling portion 5 in order to establish the flow of the operation oil at the hydraulic conduit extending between the first friction clutch C1 and the hydraulic circuit 11 in the case where the engine controlling portion 4 controls the engine 3 to be driven.

An operation of the hydraulic pressure controlling apparatus of the first embodiment in a case where the on-fail occurs at the electric oil pump 21 will be described below.

In a case where the electric oil pump 21 is in the on-fail state, where the electric oil pump 21 is actuated even if a stop command is outputted to the electric oil pump 21 from the engine controlling portion 4 and the electric oil pump controlling portion 23, the hydraulic pressure controlling apparatus alerts a driver with an alarm (e.g. a warning display at an instrument panel, an alarm sound and the like) in order to induce the driver to change the shift position of the gear lever to the forward shift stage range (i.e. either one of the D range, 3rd range, 2nd range and L range). In a case where the driver changes the shift position of the gear lever to the shift range other than the forward shift stage range, the supply of the electric power to the electric oil pump 21 is interrupted by the shift position switch 32. Accordingly, the electric oil pump 21 becomes stoppable, so that the vehicle does not start moving or being suddenly accelerated while the gear lever is positioned at N range, the P range and the R range. Additionally, even in a case where the ignition switch 31 is shifted from the position IG to the position ACC or the OFF position while the gear lever is positioned either at the D range, the 3rd range, the 2nd range or the L range, the supply of the electric power to the electric oil pump 21 is interrupted by the shift position switch 32, in addition to the above described situation where the shift position of the gear lever is changed. Accordingly, the electric oil pump 21 becomes stoppable, so that the vehicle does not start moving or being suddenly accelerated while the gear lever is positioned at N range, the P range and the R range.

A control operation of the engine controlling portion 4 of the hydraulic pressure controlling apparatus according to the first embodiment will be described below.

Firstly, the engine controlling portion 4 checks whether or not the driving condition of the electric oil pump 21 is satisfied on the basis of the vehicle condition indicated by the signals outputted from various sensors, and a preliminarily determined condition (i.e. the database) (Step S1). In a case where the driving condition of the electric oil pump 21 is not satisfied (No in step S1), the process proceeds to step S8.

On the other hand, in a case where the driving condition of the electric oil pump 21 is satisfied (Yes in step S1), the engine controlling portion 4 controls the electric oil pump 21 to be driven via the electric oil pump controlling portion 23 (step S2).

Following step S2, the engine controlling portion 4 checks whether or not the electric oil pump 21 is driven via the electric oil pump controlling portion 23 (step S3). In a case where the electric oil pump 21 is actuated (Yes in step S3), the process returns to the start of the process.

On the other hand, in a case where the electric oil pump 21 is not actuated (No in step S3), the electric oil pump 21 is in the off-fail state where the electric oil pump 21 is not actuated. Therefore, the engine controlling portion 4 controls the hydraulic pressure controlling apparatus to output the alarm (e.g. the warning display on the instrument panel, the warning sound and the like) (step S4).

Following step S4, the engine controlling portion 4 executes a control of forbidding the automatic stop of the engine 3 (step S5). The engine controlling portion 4 executes the control of forbidding the automatic stop of the engine in order to avoid an occurrence of a shock, which is likely to occur when the starting clutch (the first friction clutch C1) is engaged because the rotating number of the engine 3 (i.e. the rotating speed of the engine 3) greatly differs from a rotating number of the automatic transmission apparatus (i.e. a rotating speed of the automatic transmission apparatus). Such the difference between the rotating number of the engine 3 and the rotating number of the automatic transmission apparatus occurs due to a relay of a generation of the hydraulic pressure by the mechanical oil pump 2 when the engine 3 is re-started in the case where the electric oil pump 21 is not actuated.

Following step S5, the engine controlling portion 4 checks whether or not the engine 3 is started (step S6). In a case where the engine 3 is started, (Yes in step S6), the process returns to the start.

On the other hand, in a case where the engine 3 is not started (No in step S6), the engine controlling portion 4 executes a control of re-starting the engine 3 in order to reduce the shock to be generated when the engine 3 is re-started (step S 7). Following step S7, the process returns to the start. Additionally, a brake may be turned on while the engine controlling portion 4 executes the control of re-starting the engine 3. In this case, the shock is not likely to be generated even if the engine 3 is re-started.

In the case where the driving condition of the electric oil pump 21 is not satisfied (No in step S1), the engine controlling portion 4 controls the electric oil pump 21 to be stopped via the electric oil pump controlling portion 23 (step S8).

Following step S8, the engine controlling portion 4 checks whether or not the electric oil pump 21 is stopped via the electric oil pump controlling portion 23 (step S9). In a case where the engine controlling portion 4 determines that the electric oil pump 21 is stopped (Yes in step S9), the process returns to the start.

On the other hand, in a case where the engine controlling portion 4 determines that the electric oil pump 21 is not stopped (No in step S9), the electric oil pump 21 is in the on-fail state where the electric oil pump is still being actuated. Therefore, the engine controlling portion 4 controls the hydraulic pressure controlling apparatus to output the alarm (e.g. the warning display on the instrument panel, the warning sound and the like) (step S10).

Following step S10, the engine controlling portion 4 controls the hydraulic pressure controlling portion 10 via the transmission controlling portion 5 so as to forbid the shifting of the shift stage to any shift stage that does not use the starting clutch (the first friction clutch C1) (i.e. the fifth shift stage, the sixth shift stage and the reverse shift stage) (step S11). Then, the process returns to the start. Accordingly, the double engagement, which is likely to occur when the gear lever is positioned at any shift position that does not require the engagement of the starting clutch (the first friction clutch C1) or when the shift stage is changed to any shift stage that does not require the engagement of the starting clutch (the first friction clutch C1), and a decrease in durability of friction material, a damage of the friction material and the like may be avoidable even while the electric oil pump 21 is in the on-fail state, because of the control executed at step A11.

According to the first embodiment, in the case where the electric oil pump 21 is in the on-fail state, the supply of the electric power to the electric oil pump 21 of the hydraulic pressure maintaining portion 20 is interrupted in response to the operation of the ignition switch 31, the shift position switch 32 and the like. Accordingly, an engaged sate of the starting clutch (the first friction clutch C1) is cancelled, so that the vehicle does not start moving or being suddenly accelerated, and so that the shock, which is likely to be generated when the engine 3 is re-started, is avoided. Furthermore, because the hydraulic pressure necessary for engaging the starting clutch (the first friction clutch C1) is supplyable thereto without being influenced by a starting condition of the engine 3, the shock is not likely to be generated when the engine is re-started after being automatically stopped while the gear lever is positioned at any forward shift position. In this case, because the engine 3 is automatically stoppable and re-startable while the gear lever is positioned at the forward shift position, the fuel consumption, a noise and the like may be reduced even without the operation by the driver. Furthermore, because the shifting to the shift position or the shift stage that does not require the engagement of the starting clutch (the first friction clutch C1) is forbidden while the electric oil pump 21 is in the on-fail state, the occurrence of the double engagement (the interlock) is avoidable, which may further result in avoiding the decrease of the durability of the engagement element (the friction material) of the automatic transmission apparatus or the damage of the engagement element.

### Second Embodiment

A second embodiment of a hydraulic pressure controlling apparatus will be described below with reference to the attached drawing.

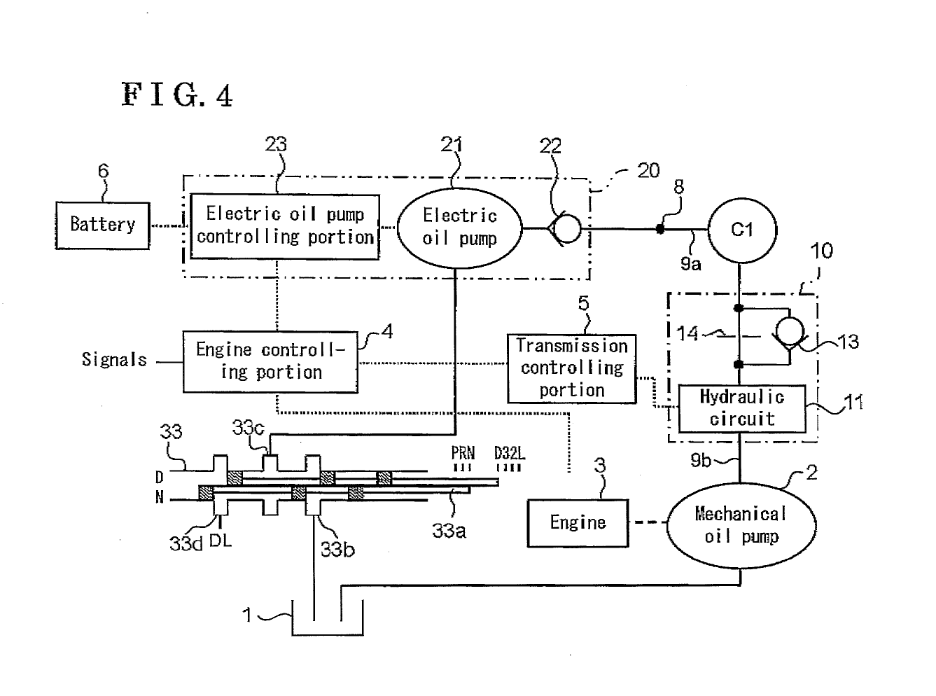

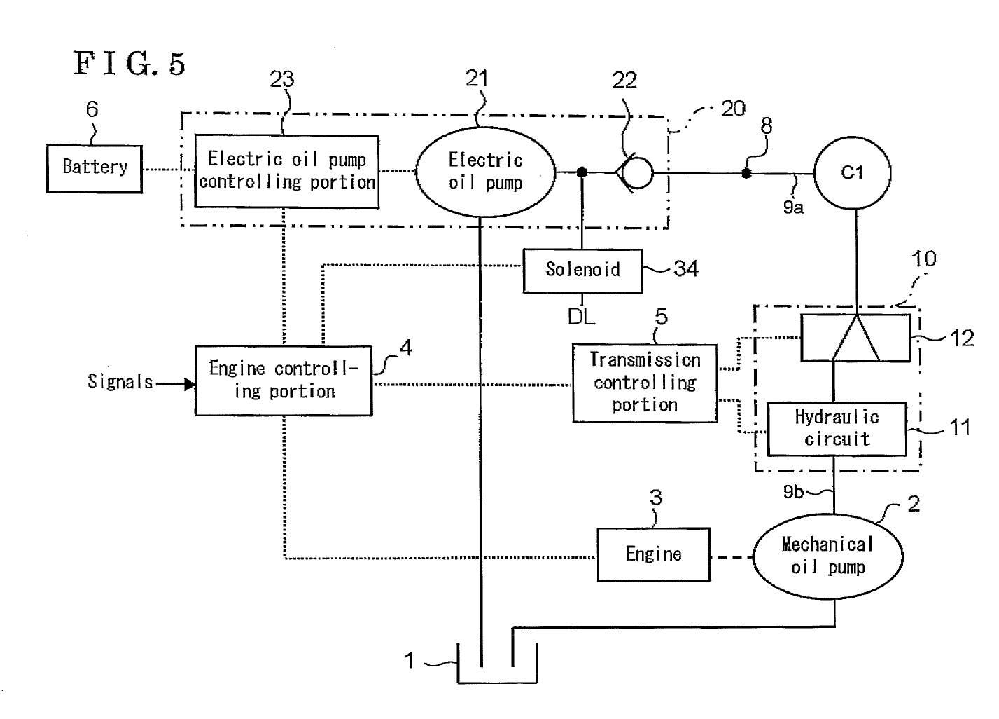

The hydraulic pressure controlling apparatus according to the second embodiment differs from the hydraulic pressure controlling apparatus according to the first embodiment in that the hydraulic pressure controlling apparatus according to the second embodiment includes the manual valve 33, which is configured so as to establish and interrupt a supply path of the operation oil from the oil pan 1 to the electric oil pump 21, instead of the ignition switch 31 and the shift position switch 32, which are configured so as to establish and interrupt the supply path of the operation oil between the battery 6 and the electric oil pump controlling portion 23 according to the first embodiment. Furthermore, in the second embodiment, a check valve 13 (i.e. a second check valve) and an orifice 14 are provided at the hydraulic pressure controlling apparatus instead of the shift valve 12 of the first embodiment. As illustrated in FIG. 4, the check valve 13 and the orifice 14 are arranged in parallel with each other at a hydraulic conduit connecting the hydraulic circuit 11 and the first friction clutch C1. The orifice 14 controls the flow of the operation oil flowing through the hydraulic conduit extending between the hydraulic circuit 11 and the first friction clutch C1. The check valve 13 is a one-way valve for supplying the operation oil from the hydraulic circuit 11 to the first friction clutch C1 in a case where the hydraulic pressure at the hydraulic circuit 11 is greater than the hydraulic pressure at the first friction clutch C1. Other configurations of the hydraulic pressure controlling apparatus according to the second embodiment are substantially similar to the hydraulic pressure controlling apparatus according to the first embodiment. Therefore, only the differences between the hydraulic pressure controlling apparatus of the first embodiment and the hydraulic pressure controlling apparatus of the second embodiment will be described below. Additionally, in the second embodiment, the battery 6 is electrically connected to the electric oil pump controlling portion 23 not via a switch and the like. However, the hydraulic pressure controlling apparatus according to the second embodiment may be modified so as to include the ignition switch (e.g. the ignition switch 31 illustrated in FIG. 1), the shift position switch (e.g. the shift position switch 32 illustrated in FIG. 1) and the like.

The manual valve 33 is a manually-actuated valve, which is configured so as to establish and interrupt the supply path of the operation oil from the oil pan 1 to the electric oil pump 21. More specifically, the manual valve 33 is configured so that a spool 33a is slidable within a valve body. The spool 33a is moved in conjunction with a shift lever. The manual valve 33 includes an input port 33b connected to the strainer of the oil pan 1, an output port 33c connected to the electric oil pump 21 and a train port 33d for discharging the operation oil from the manual valve 33. The manual valve 33 is configured so that the input port 33b and the output port 33c become in communication (i.e. the flow of the operation oil between the input port 33b and the output port 33c is established) in the case where the gear lever is positioned at the forward shift position (i.e. either at the D range, 3rd range, 2nd range and the L range). On the other hand, in the case where the gear lever is positioned at any shift position other than the forward shift positions (i.e. either at the N range, the R range and the P range), the communication between the input port 33b and the output port 33c is interrupted, and the output port 33c becomes in communication with the drain port 33d.

An operation of the hydraulic pressure controlling apparatus according to the second embodiment will be described below.

The operation of the hydraulic pressure controlling apparatus in the case where only the engine 3 is actuated is similar to the operation of the hydraulic pressure controlling apparatus according to the first embodiment in the case where only the engine 3 is actuated, without being influenced by a range of the manual valve 33.

In the case where only the electric oil pump 21 is actuated, the electric oil pump 21 sucks the operation oil from the oil pan 1 via the manual valve 33 in response to the operation of the electric oil pump 21. The oil pump discharged from the electric oil pump 21 is supplied to the first friction clutch C1 via the check valve 22 and the C1 hydraulic pressure detection port 8. In this case, the flow of the operation oil discharged from the electric oil pump 21 is stopped at the hydraulic conduit extending between the first friction clutch C1 and the hydraulic circuit 11 by means of the check valve 13, so that a few amount of the operation oil flows into the hydraulic circuit 11 via the orifice 14. Additionally, the electric oil pump 21 is controlled to be actuated by the electric oil pump controlling portion 23, which receives the control command from the engine controlling portion 4, so that the electric oil pump 21 discharges the operation oil and generates the hydraulic pressure necessary for engaging the first friction clutch C1. Furthermore, the engine controlling portion 4 monitors the condition of the vehicle such as the engine rotating number (i.e. the engine rotating speed), the oil temperature, the hydraulic pressure, the failure, the battery residual pressure and the like on the basis of the signals outputted from various sensors in order to output the control command corresponding to the monitored vehicle condition to the electric oil pump controlling portion 23. Additionally, a forward shift stage (i.e, either the D range, the 3rd range, the 2nd range and the L range) is established within the manual valve 33.

The operation of the hydraulic pressure controlling apparatus in the case where both the electric oil pump 21 and the engine 3 are actuated is similar to the operation of the hydraulic pressure controlling apparatus according to the first embodiment in the case where both the electric oil pump 21 and the engine 3 are actuated, except for the forward shift stage (i.e. either the D range, the 3rd range, the 2nd range and the L range) is established within the manual valve 33.

An operation of the hydraulic pressure controlling apparatus according to the second embodiment in the case where the electric oil pump 21 is in the on-fail state will be described below.

In the case where the electric oil pump 21 is in the on-fail state, where the electric oil pump 21 is actuated even if the stop command is outputted to the electric oil pump 21 from the engine controlling portion 4 and the electric oil pump controlling portion 23, the hydraulic pressure controlling apparatus alerts a driver with the alarm (e.g. the warning display at the instrument panel, the alarm sound and the like) in order to induce the driver to change the shift position of the gear lever to the forward shift stage range (i.e. either one of the D range, 3rd range, 2nd range and L range). In a case where the driver changes the shift position of the gear lever to the shift range other than the forward shift stage range, the hydraulic path from the oil pan 1 to the electric oil pump 21 is interrupted by the manual valve 33, so that the electric oil pump 21 does not supply the operation oil to the starting clutch (the first friction clutch C1). Accordingly, because the starting clutch (the first friction clutch C1) becomes in a disengaged state, the vehicle may not start moving or being suddenly accelerated while the gear lever is positioned at the N range, the P range and the R range.

A control operation of the engine controlling portion 4 of the hydraulic pressure controlling apparatus according to the second embodiment is similar to the control operation of the engine controlling portion 4 of the hydraulic pressure controlling apparatus according to the first embodiment.

According to the second embodiment, the hydraulic path from the oil pan 1 to the electric oil pump 21 is interrupted in response to the operation of the gear lever, which is in conjunction with the manual valve 33, while the electric oil pump 21 is in the on-fail state. Accordingly, the engagement state of the starting clutch (the first friction clutch C1) is cancelled, so that the vehicle may not start moving or being suddenly accelerated. Furthermore, the shock may be reduced when the engine 3 is re-started after being stopped.

### Third Embodiment

A third embodiment of a hydraulic pressure controlling apparatus will be described below with reference to the attached drawing.

The hydraulic pressure controlling apparatus according to the third embodiment differs from the hydraulic pressure controlling apparatus according to the second embodiment in that the hydraulic pressure controlling apparatus according to the third embodiment includes the solenoid 34 provided at the branched hydraulic conduit, which is the hydraulic conduit branched from the hydraulic conduit extending between the electric oil pump 21 and the first friction clutch C1 (whether at the hydraulic conduit arranged closer to the electric oil pump 21 relative to the check valve 22 or the hydraulic conduit arranged closer to the first friction clutch C1 relative to the check valve 22), instead of the manual valve 33 of the second embodiment configured so as to establish and interrupt the supply path of the operation oil from the oil pan 1 to the electric oil pump 21. Furthermore, the hydraulic pressure controlling apparatus according to the third embodiment includes the shift valve 12 similar to the shift valve 12 of the first embodiment, instead of the check valve 13 and the orifice 14 of the hydraulic pressure controlling apparatus according to the second embodiment. Other configurations of the hydraulic pressure controlling apparatus according to the third embodiment are similar to the hydraulic pressure controlling apparatus according to the second embodiment. Additionally, the configuration of the hydraulic pressure controlling apparatus according to the first and second embodiments may be added to the hydraulic pressure controlling apparatus according to the third embodiment in view of an occurrence of a malfunction.

The solenoid 34 is an electromagnetic valve, which is provided on the branched hydraulic conduit, which is the hydraulic conduit branched from the hydraulic conduit connecting the electric oil pump 21 and the check valve 22 toward a discharge hydraulic conduit DL. The solenoid 34 is controlled by the engine controlling portion 4. More specifically, the engine controlling portion 4 controls the solenoid 34 so that the hydraulic conduit between the electric oil pump 21 and the check valve 22 becomes in communication with the discharge hydraulic conduit DL in the case where the electric oil pump 21 is in the on-fail state. On the other hand, in a case where the electric oil pump 21 is in a state other than the on-fail state, the engine controlling portion 4 controls the solenoid 34 so that the communication between the hydraulic conduit extending between the electric oil pump 21 and the check valve 22 and the discharge hydraulic conduit DL is interrupted.

An operation of the hydraulic pressure controlling apparatus according to the third embodiment will be described below.

An operation of the hydraulic pressure controlling apparatus in the case where only the engine 3 is driven is similar to the operation of the hydraulic pressure controlling apparatus according to the first embodiment in the case where only the engine 3 is driven, without being influenced by an operation of the solenoid 34.

In the case where only the electric oil pump 21 is actuated, the electric oil pump 21 sucks the operation oil from the oil pan 1 in response to the operation of the electric oil pump 21. The operation oil discharged from the electric oil pump 21 is supplied to the first friction clutch C1 via the check valve 22 and the C1 hydraulic pressure detection port 8. In this case, the communication of the operation oil at the hydraulic conduit extending between the electric oil pump 21 and the check valve 22 on the one hand and the discharge hydraulic conduit DL on the other hand is interrupted by the solenoid 34, so that the operation oil is not discharged from the electric oil pump 21 to the discharge hydraulic conduit DL. Furthermore, the flow of the operation oil at the hydraulic conduit between the first friction clutch C1 and the hydraulic circuit 11 is interrupted by the shift valve 12, so that the operation oil supplied to the first friction clutch C1 from the electric oil pump 21 does not flow into the hydraulic circuit 11. Accordingly, the leakage of the operation oil is limited to the small amount leaked from the clearance formed at the shift valve 12, in other words, the leakage of the operation oil is limited to a very small amount. Therefore, the electric oil pump 21 may be configured so as to have a minimum volume necessary for engaging the first friction clutch C1. Additionally, the electric oil pump 21 is controlled to be driven by the electric oil pump controlling portion 23, which receives the control command from the engine controlling portion 4, in order to control the hydraulic pressure and the flow of the operation oil so as to be sufficient to engage the first friction clutch C1. Furthermore, the engine controlling portion 4 monitors the condition of the vehicle such as the engine rotating number (i.e. the engine rotating speed), the oil temperature, the hydraulic pressure, the failure, the battery residual pressure and the like on the basis of the signals outputted from various sensors in order to output the control command corresponding to the monitored vehicle condition to the electric oil pump controlling portion 23. Furthermore, the engine controlling portion 4 controls the shift valve 12 via the transmission controlling portion 5 in order to interrupt the hydraulic path established between the clutch C1 and the hydraulic circuit 11 in the case where the engine controlling portion 4 controls the electric oil pump 21 to be driven and the engine 3 to be stopped. Moreover, the engine controlling portion 4 controls the solenoid 34 so as to interrupt the flow of the operation oil between the hydraulic conduit extending between the electric oil pump 21 and the check valve 22 and the discharge hydraulic conduit DL.

An operation of the hydraulic pressure controlling apparatus according to the third embodiment in the case where both the electric oil pump 21 and the engine 3 are actuated is similar to the operation of the hydraulic pressure controlling apparatus according to the first embodiment in the case where both the electric oil pump 21 and the engine 3 are actuated, except that the engine controlling portion 4 controls the solenoid 34 so as to interrupt communication of the operation oil between the hydraulic conduit, extending between the electric oil pump 21 and the check valve 22, and the discharge hydraulic conduit DL.

An operation of the hydraulic pressure controlling apparatus according to the third embodiment in the case where the electric oil pump 21 is in the on-fail state will be described below.

In the case where the electric oil pump 21 is in the on-fail state, where the electric oil pump 21 is actuated even if the stop command is outputted thereto from the engine controlling portion 4 and the electric oil pump controlling portion 23, the engine controlling portion 4 controls the solenoid 34 so as to establish the communication between the hydraulic conduit extending between the electric oil pump 21 and the check valve 22 and the discharge hydraulic conduit DL, so that the operation oil outputted from the electric oil pump 21 is discharged from the discharge hydraulic conduit DL. As a result, the electric oil pump 21 is turned to be in a state where the electric oil pump 21 does not supply the operation oil to the starting clutch (the first friction clutch C1), so that the starting clutch (the first friction clutch C1) is turned to be in the disengaged state. Accordingly, the vehicle may not be started or suddenly accelerated contrary to an intention of the driver.

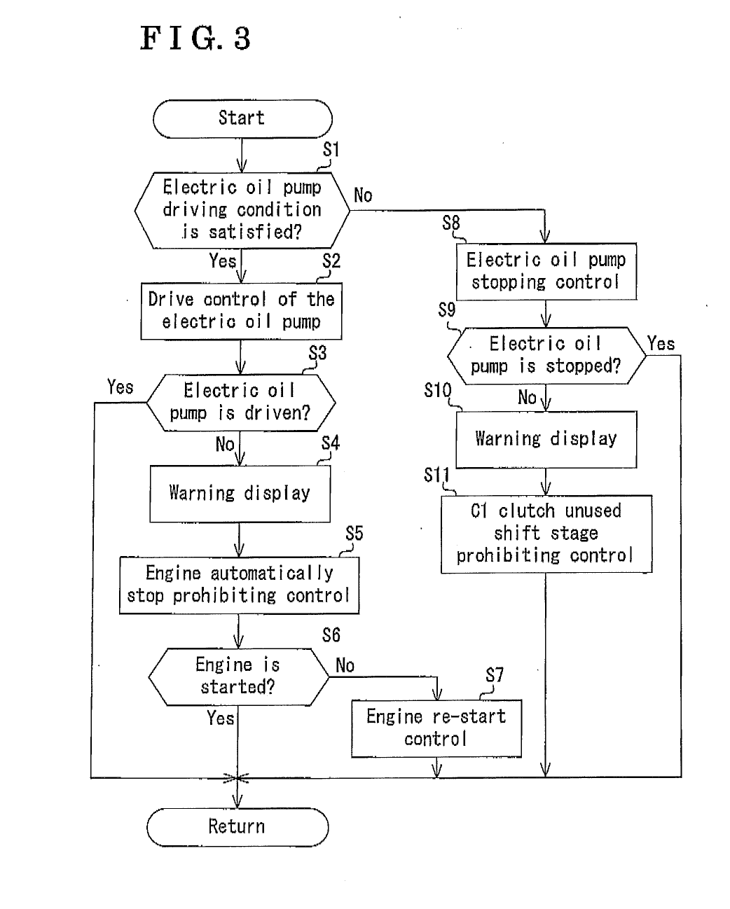

A control operation of the engine controlling portion 4 of the hydraulic pressure controlling apparatus according to the third embodiment is similar to the control operation of the engine controlling portion 4 of the hydraulic pressure controlling apparatus according to the first embodiment except that the engine controlling portion 4 controls the solenoid 34 so as to establish the communication between the hydraulic conduit extending between the electric oil pump 21 and the check valve 22 and the discharge hydraulic conduit DL in the case where the engine controlling portion 4 executes the control of forbidding the shifting to the shift stage (i.e. the fifth shift stage, the sixth shift stage and the reverse shift stage) that does not require the engagement of the starting clutch (the first friction clutch C1) in step S11 (see FIG. 3) in the first embodiment.

According to the third embodiment, the solenoid 34 is provided at the divergent hydraulic conduit, which is the hydraulic conduit diverged from the hydraulic conduit connecting the electric oil pump 21 and the starting clutch (the first friction clutch C1). Accordingly, even in the case where the electric oil pump 21 is in the on-fail state, the operation oil supplied from the electric oil pump 21 is discharged from the discharge hydraulic conduit DL, so that the engagement state of the starting clutch (the first friction clutch C1) is cancelled. As a result, the vehicle may not be started or suddenly accelerated even in the case where the gear lever is positioned at a non-driving shift position or a reverse shift position.

According to the embodiments, the engine controlling portion 4 controls the hydraulic pressure controlling portion 10 so that the shifting to the shift stage, which is likely to induce the interlock at the automatic transmission apparatus when the first friction clutch C1 is engaged, is forbidden in the case where the engine controlling portion 4 determines that the electric oil pump 21 is in the on-fail state.

According to the second embodiment, the hydraulic pressure supply interrupting mechanism includes one or more of the manual switch, which is configured so as to interrupt the supply path of the electric power between the battery 6 and the electric oil pump 21.

According to the second embodiment, the hydraulic pressure supply interrupting mechanism includes the manual valve 33, which is configured so as to interrupt the hydraulic path between the oil pan 1 and the electric oil pump 21.

According to the embodiments, the hydraulic pressure controlling apparatus further includes the check valve 22 provided at the first hydraulic conduit 9a connecting the first friction clutch C1 and the electric oil pump 21. The check valve 22 is configured so as to allow the supply of the hydraulic pressure from the electric oil pump 21 to the first friction clutch C1 and to forbid the reverse supply of the hydraulic pressure from the first friction clutch C1 to the electric oil pump 21. The electric oil pump 21 supplies the hydraulic pressure to the first friction clutch C1 via the first hydraulic conduit 9a, which differs from the second hydraulic conduit 9b connected to the hydraulic pressure controlling portion 10.

According to the first and third embodiments, the hydraulic pressure controlling portion 10 includes the hydraulic circuit 11, to which the hydraulic pressure is supplied from the mechanical oil pump 2, and the shift valve 12 provided at the hydraulic conduit extending between the hydraulic circuit 11 and the first friction clutch C1 and switching the state of the shift valve 12 between the state of forbidding the hydraulic pressure supplied to the first friction clutch C1 from the electric oil pump 21 to flow into the hydraulic circuit 11 and the state of allowing the hydraulic pressure from the mechanical oil pump 2 to be supplied the first friction clutch C1. The engine controlling portion 4 controls the flow of the operation oil flowing through the hydraulic circuit 11 and the operation of the shift valve 12 via the transmission controlling portion 5.

According to the second embodiment, the hydraulic pressure controlling portion 10 includes the hydraulic circuit 11, to which the hydraulic pressure is supplied from the mechanical oil pump 2, the check valve 13 provided at the hydraulic conduit between the hydraulic circuit 11 and the first friction clutch C1, and allowing the supply of the hydraulic pressure from the mechanical oil pump 2 to the first friction clutch C1 and forbidding the supply of the hydraulic pressure supplied to the first friction clutch C1 from the electric oil pump 21, and the orifice 14 arranged in parallel with the check valve 13 at the hydraulic conduit between the hydraulic circuit 11 and the first friction clutch C1 and controlling the flow of the operation oil flowing through the hydraulic conduit between the hydraulic circuit 11 and the first friction clutch C1. The engine controlling portion 4 controls the flow of the operation oil flowing through the hydraulic circuit 11 via the transmission controlling portion 5.

According to the embodiments, the engine controlling portion 4 determines whether or not the condition of driving the electric oil pump 21 is satisfied on the basis of the signal indicating the predetermined condition of the vehicle. The engine controlling portion 4 controls the electric oil pump 21 so as to forbid the driving of the electric oil pump 21 via the electric oil pump controlling portion 23 in the case where the engine controlling portion 4 determines that the condition of driving the electric oil pump 21 is not satisfied.

According to the embodiments, the power source includes at least one of the engine 3 and the motor.

According to the embodiments, the first hydraulic conduit 9a, which differs from the second hydraulic conduit 9b connected to the hydraulic pressure controlling portion 10, is connected to the detection port 8 for detecting the hydraulic pressure supplied to the first friction clutch C1.

Accordingly, the shifting to the shift position or the shift stage that does not require the engagement of the first friction clutch C1 is forbidden in the case where the electric oil pump 21 is in the on-fail state. As a result, the occurrence of the double engagement (the interlock) may be avoided, and the decrease of the durability of the friction material of the automatic transmission apparatus and the occurrence of the damage of the friction material may be avoided. Furthermore, because the hydraulic pressure controlling apparatus according to the embodiments is achievable without design change of the hydraulic pressure controlling portion 10, the hydraulic pressure controlling apparatus according to the embodiments may be achieved at relatively low manufacturing costs.

Accordingly, because the supply path of the electric port to the electric oil pump 21 is interrupted in response to the operation of the manual switch in the case where the electric oil pump 21 is in the on-fail state, the engagement state of the first friction clutch C1 is cancelled, so that the vehicle may not start moving or suddenly accelerate. Furthermore, the shock is not likely to be generated when the engine 3 is re-started after being stopped. Moreover, because the hydraulic pressure controlling apparatus according to the embodiments is achievable without design change of the hydraulic pressure controlling portion 10, the hydraulic pressure controlling apparatus according to the embodiments may be achieved at the relatively low manufacturing costs.

Accordingly, because the hydraulic path from the oil pan 1 to the electric oil pump 21 is interrupted in response to the operation of the gear lever, which is moved in conjunction with the manual valve 33, in the case where the electric oil pump 21 is in the on-fail state, the engagement state of the first friction clutch C1 is cancelled, so that the vehicle may not start moving or suddenly accelerate. Furthermore, the occurrence of the shock when the engine 3 is re-started after being stopped may be avoided. Furthermore, because the hydraulic pressure controlling apparatus according to the embodiments is achievable without design change of the hydraulic pressure controlling portion 10, the hydraulic pressure controlling apparatus according to the embodiments may be achieved at the relatively low manufacturing costs.

Accordingly, because the solenoid 34 is provided at the branched hydraulic conduit, which is the hydraulic conduit branched from the hydraulic conduit extending between the electric oil pump 21 and the first friction clutch C1 toward the discharge hydraulic conduit DL, the operation oil outputted from the electric oil pump 21 is discharged from the discharge hydraulic conduit DL even in the case where the electric oil pump 21 is turned to be in the on-fail state. Accordingly, the engagement state of the first friction clutch C1 is cancelled, so that the vehicle may not start or suddenly accelerate even in the case where the gear lever is positioned at a non-drive shift position or the reverse shift position. Furthermore, because the hydraulic pressure controlling apparatus according to the embodiments is achievable without design change of the hydraulic pressure controlling portion 10, the hydraulic pressure controlling apparatus according to the embodiments may be achieved at the relatively low manufacturing costs.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the disclosure. Accordingly, it is expressly intended that all such variations, changes and equivalents which fall within the spirit and scope of the present invention as defined in the claims, be embraced thereby.

1. A hydraulic pressure controlling apparatus comprising:
a hydraulic pressure controlling portion controlling a hydraulic pressure supplied to a plurality of engagement elements of an automatic transmission apparatus;
a mechanical oil pump supplying the hydraulic pressure to the hydraulic pressure controlling portion in response to a driving of a power source;
an electric oil pump supplying the hydraulic pressure to a starting shift stage engagement element, which is one of the plurality of engagement elements used for establishing a starting shift stage; and
an electronic controlling portion controlling operations of the hydraulic pressure controlling portion, the power source and the electronic oil pump on the basis of a signal indicating a predetermined state of a vehicle, wherein
the electronic controlling portion controls the hydraulic pressure controlling portion so as to forbid a shifting to a shift stage, which is likely to induce an interlock at the automatic transmission apparatus, on the basis of an engagement of the starting shift stage engagement element in a case where the electronic controlling portion determines that the electric oil pump is in an on-fail state.

2. A hydraulic pressure controlling apparatus comprising:
a hydraulic pressure controlling portion controlling a hydraulic pressure supplied to a plurality of engagement elements of an automatic transmission apparatus;
a mechanical oil pump supplying the hydraulic pressure to the hydraulic pressure controlling portion in response to a driving of a power source;
an electric oil pump supplying the hydraulic pressure to a starting shift stage engagement element, which is one of the plurality of engagement elements used for establishing a starting shift stage;
an electronic controlling portion controlling operations of the hydraulic pressure controlling portion, the power source and the electronic oil pump on the basis of a signal indicating a predetermined state of a vehicle; and
a hydraulic pressure supply interrupting mechanism for interrupting a supply of the hydraulic pressure from the electric oil pump to the starting shift stage engagement element.

3. A hydraulic pressure controlling apparatus comprising:
a hydraulic pressure controlling portion controlling a hydraulic pressure supplied to a plurality of engagement elements of an automatic transmission apparatus;
a mechanical oil pump supplying the hydraulic pressure to the hydraulic pressure controlling portion in response to a driving of a power source;
an electric oil pump supplying the hydraulic pressure to a starting shift stage engagement element, which is one of the plurality of engagement elements used for establishing a starting shift stage;
a solenoid provided at a branched hydraulic conduit, which is a hydraulic conduit branched from a hydraulic conduit extending between the electric oil pump and the starting shift stage engagement element; and
an electronic controlling portion controlling operations of the hydraulic pressure controlling portion, the power source, the electronic oil pump and the solenoid on the basis of a signal indicating a predetermined state of a vehicle.

4. The hydraulic pressure controlling apparatus according to claim 2, wherein the electronic controlling portion controls the hydraulic pressure controlling portion so that a shifting to a shift stage, which is likely to induce an interlock at the automatic transmission apparatus when the starting shift stage engagement element is engaged, is forbidden in a case where the electronic controlling portion determines that the electric oil pump is in an on-fail state.

5. The hydraulic pressure controlling apparatus according to claim 2, wherein the hydraulic pressure supply interrupting mechanism includes one or more of a manual switch, which is configured so as to interrupt a supply path of an electric power between an electric power source and the electric oil pump.

6. The hydraulic pressure controlling apparatus according to claim 2, wherein the hydraulic pressure supply interrupting mechanism includes a manual valve, which is configured so as to interrupt a hydraulic path between an oil pan and the electric oil pump.

7. The hydraulic pressure controlling apparatus according to claim 1 further comprising a first check valve provided at a first hydraulic conduit connecting the starting shift stage engagement element and the electric oil pump, allowing a supply of the hydraulic pressure from the electric oil pump to the starting shift stage engagement element and forbidding a reverse supply of the hydraulic pressure from the starting shift stage engagement element to the electric oil pump, wherein the electric oil pump supplies the hydraulic pressure to the starting shift stage engagement element via the first hydraulic conduit, which differs from a second hydraulic conduit connected to the hydraulic pressure controlling portion.

8. The hydraulic pressure controlling apparatus according to claim 1, wherein the hydraulic pressure controlling portion includes a hydraulic circuit, to which the hydraulic pressure is supplied from the mechanical oil pump, and a shift valve provided at a hydraulic conduit extending between the hydraulic circuit and the starting shift stage engagement element and switching a state of the shift valve between a state of forbidding the hydraulic pressure supplied to the starting shift stage engagement element from the electric oil pump to flow into the hydraulic circuit and a state of allowing the hydraulic pressure from the mechanical oil pump to be supplied to the starting shift stage engagement element, wherein the electronic controlling portion controls a flow of an operation fluid flowing through the hydraulic circuit and an operation of the shift valve.

9. The hydraulic pressure controlling apparatus according to claim 1, wherein the hydraulic pressure controlling portion includes a hydraulic circuit, to which the hydraulic pressure is supplied from the mechanical oil pump, a second check valve provided at a hydraulic conduit between the hydraulic circuit and the starting shift stage engagement element, and allowing a supply of the hydraulic pressure from the mechanical oil pump to the starting shift stage engagement element and forbidding the supply of the hydraulic pressure supplied to the starting shift stage engagement element from the electric oil pump, and an orifice arranged in parallel with the second check valve at the hydraulic conduit between the hydraulic circuit and the starting shift stage engagement element and controlling a flow of an operation fluid flowing through the hydraulic conduit between the hydraulic circuit and the starting shift stage engagement element, wherein the electronic controlling portion controls the flow of the operation fluid flowing through the hydraulic circuit.

10. The hydraulic pressure controlling apparatus according to claim 1, wherein the electronic controlling portion determines whether or not a condition of driving the electric oil pump is satisfied on the basis of the signal indicating the predetermined condition of the vehicle, and the electronic controlling portion controls the electric oil pump so as to forbid a driving of the electric oil pump in a case where the electronic controlling portion determines that the condition of driving the electric oil pump is not satisfied.

11. The hydraulic pressure controlling apparatus according to claim 1, wherein the power source includes at least one of an engine and a motor.

12. The hydraulic pressure controlling apparatus according to claim 1, wherein a first hydraulic conduit, which differs from a second hydraulic conduit connected to the hydraulic pressure controlling portion, is connected to a detection port for detecting the hydraulic pressure supplied to the starting shift stage engagement element.

13. The hydraulic pressure controlling apparatus according to claim 2 further comprising a first check valve provided at a first hydraulic conduit connecting the starting shift stage engagement element and the electric oil pump, allowing a supply of the hydraulic pressure from the electric oil pump to the starting shift stage engagement element and forbidding a reverse supply of the hydraulic pressure from the starting shift stage engagement element to the electric oil pump, wherein the electric oil pump supplies the hydraulic pressure to the starting shift stage engagement element via the first hydraulic conduit, which differs from a second hydraulic conduit connected to the hydraulic pressure controlling portion.

14. The hydraulic pressure controlling apparatus according to claim 3 further comprising a first check valve provided at a first hydraulic conduit connecting the starting shift stage engagement element and the electric oil pump, allowing a supply of the hydraulic pressure from the electric oil pump to the starting shift stage engagement element and forbidding a reverse supply of the hydraulic pressure from the starting shift stage engagement element to the electric oil pump, wherein the electric oil pump supplies the hydraulic pressure to the starting shift stage engagement element via the first hydraulic conduit, which differs from a second hydraulic conduit connected to the hydraulic pressure controlling portion.

15. The hydraulic pressure controlling apparatus according to claim 2, wherein the hydraulic pressure controlling portion includes a hydraulic circuit, to which the hydraulic pressure is supplied from the mechanical oil pump, and a shift valve provided at a hydraulic conduit extending between the hydraulic circuit and the starting shift stage engagement element and switching a state of the shift valve between a state of forbidding the hydraulic pressure supplied to the starting shift stage engagement element from the electric oil pump to flow into the hydraulic circuit and a state of allowing the hydraulic pressure from the mechanical oil pump to be supplied to the starting shift stage engagement element, wherein the electronic controlling portion controls a flow of an operation fluid flowing through the hydraulic circuit and an operation of the shift valve.

16. The hydraulic pressure controlling apparatus according to claim 3, wherein the hydraulic pressure controlling portion includes a hydraulic circuit, to which the hydraulic pressure is supplied from the mechanical oil pump, and a shift valve provided at a hydraulic conduit extending between the hydraulic circuit and the starting shift stage engagement element and switching a state of the shift valve between a state of forbidding the hydraulic pressure supplied to the starting shift stage engagement element from the electric oil pump to flow into the hydraulic circuit and a state of allowing the hydraulic pressure from the mechanical oil pump to be supplied to the starting shift stage engagement element, wherein the electronic controlling portion controls a flow of an operation fluid flowing through the hydraulic circuit and an operation of the shift valve.

17. The hydraulic pressure controlling apparatus according to claim 2, wherein the hydraulic pressure controlling portion includes a hydraulic circuit, to which the hydraulic pressure is supplied from the mechanical oil pump, a second check valve provided at a hydraulic conduit between the hydraulic circuit and the starting shift stage engagement element, and allowing a supply of the hydraulic pressure from the mechanical oil pump to the starting shift stage engagement element and forbidding the supply of the hydraulic pressure supplied to the starting shift stage engagement element from the electric oil pump, and an orifice arranged in parallel with the second check valve at the hydraulic conduit between the hydraulic circuit and the starting shift stage engagement element and controlling a flow of an operation fluid flowing through the hydraulic conduit between the hydraulic circuit and the starting shift stage engagement element, wherein the electronic controlling portion controls the flow of the operation fluid flowing through the hydraulic circuit.

18. The hydraulic pressure controlling apparatus according to claim 3, wherein the hydraulic pressure controlling portion includes a hydraulic circuit, to which the hydraulic pressure is supplied from the mechanical oil pump, a second check valve provided at a hydraulic conduit between the hydraulic circuit and the starting shift stage engagement element, and allowing a supply of the hydraulic pressure from the mechanical oil pump to the starting shift stage engagement element and forbidding the supply of the hydraulic pressure supplied to the starting shift stage engagement element from the electric oil pump, and an orifice arranged in parallel with the second check valve at the hydraulic conduit between the hydraulic circuit and the starting shift stage engagement element and controlling a flow of an operation fluid flowing through the hydraulic conduit between the hydraulic circuit and the starting shift stage engagement element, wherein the electronic controlling portion controls the flow of the operation fluid flowing through the hydraulic circuit.

19. The hydraulic pressure controlling apparatus according to claim 2, wherein the electronic controlling portion determines whether or not a condition of driving the electric oil pump is satisfied on the basis of the signal indicating the predetermined condition of the vehicle, and the electronic controlling portion controls the electric oil pump so as to forbid a driving of the electric oil pump in a case where the electronic controlling portion determines that the condition of driving the electric oil pump is not satisfied.

20. The hydraulic pressure controlling apparatus according to claim 3, wherein the electronic controlling portion determines whether or not a condition of driving the electric oil pump is satisfied on the basis of the signal indicating the predetermined condition of the vehicle, and the electronic controlling portion controls the electric oil pump so as to forbid a driving of the electric oil pump in a case where the electronic controlling portion determines that the condition of driving the electric oil pump is not satisfied.
